(19) United States
(12) Patent Application Publication
(10) Pub. No.: US 2025/0029759 A1
(43) Pub. Date: Jan. 23, 2025

(54) INDUCTOR AND METHOD FOR MANUFACTURING SAME

(71) Applicants: HUIZHOU POCO NEW INDUCTOR TECHNOLOGY CO., LTD., Huizhou City (CN); SHENZHEN POCO MAGNETIC CO., LTD., Shenzhen City (CN); HUIZHOU POCO INDUSTRY CO., LTD., Huizhou City (CN); HEYUAN POCO MAGNETIC CO., LTD., Heyuan City (CN)

(72) Inventors: YUNFAN ZHANG, Shenzhen City (CN); XIONGZHI GUO, Shenzhen City (CN); LINA ZHANG, Shenzhen City (CN); YAQING LI, Shenzhen City (CN)

(21) Appl. No.: 18/772,259

(22) Filed: Jul. 14, 2024

(30) Foreign Application Priority Data
Jul. 17, 2023 (CN) 202310877677.2

(51) Int. Cl. H01F 3/08; H01F 1/147; H01F 27/28; H01F 41/02

(52) U.S. Cl. CPC H01F 3/08; H01F 27/2823; H01F 41/0246; H01F 1/14741; H01F 1/14791

(57) ABSTRACT

An inductor provided in the present invention, includes a magnetic core made of soft magnetic powder and a wire coil embedded inside the magnetic core. A method for manufacturing the inductor includes steps of: a pressing and molding step; and an annealing step. At the pressing and molding step, placing a wire coil in a mold, filling a cavity of the mold with soft magnetic powder surrounding the wire coil, molding at a pressure of 12˜24 T/cm² to obtain a raw inductor. At the annealing step, placing the raw inductor in a heat furnace for calcinating and annealing so as to release residual stress inside the magnetic core and obtain the integrated inductor. In the present invention, a high-density, high-permeability inductor can be obtained, and no need to limit powder particle size of the soft magnetic powder.

### CROSS REFERENCE TO RELATED APPLICATIONS

The present invention is 35 U.S.C. § 119 benefit of earlier filing dates; rights of priority of Chinese Applications No. 202310877677. 2 filed on Jul. 17, 2023, the disclosure of which is incorporated by reference herein.

### BACKGROUND OF THE INVENTION

### Field of the Invention

The present invention relates to the field of electronic components, and more particularly, to an inductor and a method for manufacturing the same.

### Description of Related Art

Power inductors generally refer to inductors used in power supply circuits such as DC-DC converters, and mainly play the roles of voltage stabilization, filtering and signal processing in the circuit. With the rapid development of electronic technology, the frequencies of CPUs, GPUs, etc. are getting higher and higher, which puts forward higher needs for stable power supply and filtering, and drives the development of power inductors in the direction of miniaturization, thinness and lightweight. At the same time, power inductors are also required to have high reliability to maintain the normal operation of electronic equipment.

There are two common types of power inductors, wire-wound type and integrated type.

Wire-wound inductors mainly use Fe magnetic material, which has the disadvantage of low saturation magnetic flux density. If the operating current is large, saturation will occur; at the same time, the wire-wound type is an assembly structure, and there is air gap between the Fe and the wire; which hinder the inductor in miniaturization.

In an integrated (one-piece) inductor, magnetic powder and organic resin are mixed to form a composite, and the composite and wires are placed in a mold and press-molded to obtain an inductor with the wires embedded inside a magnetic core. For one-piece inductors, if the molding pressure is too low, the density of the magnetic core of the inductor will be low and the initial magnetic permeability will be low, which make it impossible to obtain the required electromagnetic properties. If the molding pressure is too high, it will cause the wires inside the magnetic powder to be subjected to excessive extrusion force, and the insulation layer on the surface of the enameled copper wires is damaged, which will result in a low insulation resistance of the product or even short circuit, and lower product reliability. The existing one-piece molding process for manufacturing the integrated inductor uses the molding pressure lower than 10 T/cm²; otherwise, due to the low insulation resistance of the wires, short circuits are prone to occur when the inductor is connected in a circuit.

The inductor disclosed in the Chinese Patent No. CN103714961B, the density of the magnetic material inside the wire coil is higher than the density of the magnetic material outside the wire coil, so as to achieve the effect of high initial magnetic permeability. However, this method requires filling powder multiple times and pressing multiple times, which increases the production steps and difficulty, and reduces production efficiency. The inductor disclosed in Chinese Patent No. CN111151740B by means of injection molding, has a magnetic permeability of 21.6. In order to meet the required electromagnetic properties, a multi-layer coil needs to be used, which results in a large DC resistance of the inductor, reduces efficiency, and is not advantageous to obtain a flat-coil inductor. In addition, the production efficiency of injection molding is low.

### SUMMARY OF THE INVENTION

An object of the present invention is to is to provide an inductor which is manufactured by co-firing/integrated molding of magnetic powder and wire coils, which can meet the required electromagnetic properties, the manufacturing process is simple and improves production efficiency.

An inductor provided by the present invention, comprises a magnetic core, made of soft magnetic powder; and a wire coil embedded inside the magnetic core through an integrated molding. The soft magnetic powder contains more than 50 wt % of spherical particles; the inductor components are made by integrated molding at a molding pressure of 12˜24 T/cm².

Preferably, a sphericity of the spherical particles is not less than 95%; the soft magnetic powder contains more than 80 wt % spherical particles; and the molding pressure is 16˜22 T/cm².

More preferably, all the soft magnetic powders are spherical particles; the molding pressure is 18˜20 T/cm².

In some embodiments, the soft magnetic powder is Fe-based magnetic powder.

In some embodiments, the soft magnetic powder is one or more of Fe powder, Fe—Si powder, Fe—Ni powder, Fe—Si—Cr powder, or Fe—Si—Al powder.

In some embodiments, the soft magnetic powder is Fe-based amorphous magnetic powder.

In some embodiments, the soft magnetic powder is nanocrystalline magnetic powder.

In some embodiments, the wire coil is a linear or spiral coil, and a number of turns in the wire coil is less than 4. Preferably, a number of turns in the wire coil is 2.

More preferably, the wire coil is a single-turn and straight coil.

More preferably, the wire coil is a copper conductor and is straight.

In some embodiments, the soft magnetic powder is provided with an insulating layer on each particle surface. Specifically, the insulating layer has a high resistivity and flexibility such that the particles are not in complete contact to reduce an eddy current and increase an insulation resistance of the inductor; and insulating material of the insulating layer has a bonding property to improve a strength of the inductor.

A method for manufacturing an inductor, provided by the present invention, comprises a pressing and molding step; and an annealing step. At the pressing and molding step, placing a wire coil in a mold, filling a cavity of the mold with soft magnetic powder surrounding the wire coil, molding at a pressure of 12˜24 T/cm² to obtain a raw inductor with the wire coil buried inside a magnetic core and leads of the wire coil exposed on a surface of the magnetic core; the soft magnetic powder contains more than 50 wt % spherical particles; and at the annealing step, placing the raw inductor in a heat furnace for calcinating and annealing so as to release residual stress inside the magnetic core and obtain the integrated inductor.

The advantages of the present invention are:

The inductor provided by the present invention has a high initial magnetic permeability and good insulation withstand voltage. That is, the inductor can still maintain high withstand voltage even under a high molding pressure, ensuring that the inductor has excellent electromagnetic properties and reliability. At the same time, the method for manufacturing the inductor is simple and has high production efficiency.

### BRIEF DESCRIPTION OF DRAWINGS

FIG. 1 illustrates sphericities of soft magnetic powder in accordance with an embodiment of the present invention;

FIG. 2 is an SEM image of Fe—Si—Al powder with a sphericity≥95% in accordance with an embodiment of the present invention;

FIG. 3 is an SEM image of Fe—Si—Cr powder with a sphericity≥50% in accordance with an embodiment of the present invention;

FIG. 4 is an SEM image of irregularly-shaped Fe—Si—Cr powder;

FIG. 5 is a graph showing a relationship between a molding pressure and a density of the magnetic core of the inductor;

FIG. 6 is a graph showing a relationship between a magnetic permeability and an insulation resistance;

FIG. 7(a) illustrates an interaction between powder particles and a wire coil of inductor;

FIG. 7(b) illustrates an interaction between powder particles; and

FIGS. 8(a)-8(e) show the inductors in accordance with some embodiments of the present invention, wherein FIGS. 8(a), 8(d), and 8(e) show the inductors with single-turn wire coil embedded in the magnetic core; FIG. 8(b) shows the inductors with two-turn wire coil embedded in the magnetic core, and FIG. 8(c) shows the inductors with three-turn wire coil embedded in the magnetic core.

### DETAILED DESCRIPTION OF THE INVENTION

An inductor is described herein. Exemplary embodiments of the present invention will be described in more detail below with reference to the accompanying drawings. Although exemplary embodiments of the present invention are shown in the drawings, it should be understood that the present invention may be implemented in various forms and should not be limited to the embodiments described below. Rather, these embodiments are provided to enable those skilled in the art to completely understand the present invention.

The experimental methods described in the following examples, if no special limitations are given, are conventional methods; the reagents and materials, if no special limitations are given, can be obtained from commercial sources.

Numerical values or value ranges disclosed herein are not limited to the precise values or range, but should be understood to include values approaching these ranges or values. For numerical ranges, the endpoints and any point values within the range, individual or combined with each other to obtain one or more new value ranges, shall be deemed to be specifically disclosed herein.

The present invention provides an inductor including a magnetic core made of soft magnetic powder/particles and a wire coil embedded inside the magnetic core. The soft magnetic powder/particles for preparing the magnetic core contains more than 50 wt % spherical particles with a sphericity of not less than 95% and without obvious bulges or protruding on the particle surface.

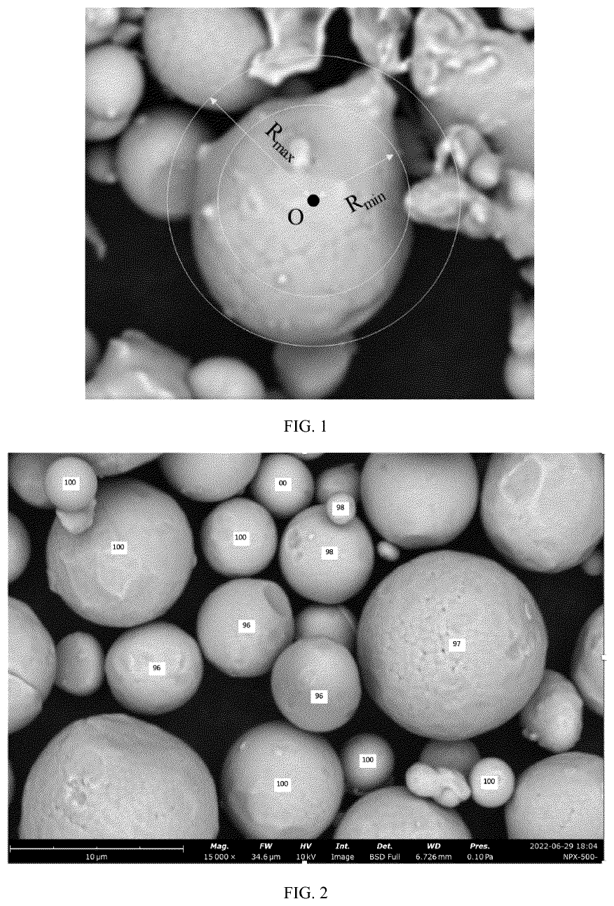

A sphericity of the spherical particle is calculated by the following formula.

$$Sphericiyt = \frac{( {R}_{max} - {R}_{min} )}{2 {R}_{max}} \times 100 \%$$

where, referring to FIG. 1, Rmax refers to: a radius of the smallest circle tangent to an outer contour of the powder particle; Rmin refers to a minimum distance from the center O of the smallest circle to the particle surface.

In the present invention, soft magnetic particles each with a high sphericity and smooth particle surface, are used for a high-pressure molding (molding pressure is greater than 10 T/cm²) for manufacturing the magnetic core of the inductor with a high withstand voltage and high magnetic properties.

High-pressure molding makes the inductor have a high magnetic permeability such as greater than 40, which can reduce the usage of the wire coil, reduce DC resistance, and improve inductor efficiency under a high current. The high magnetic permeability can also reduce a volume of the magnetic core, thus a smaller and thinner inductor can be made.

The inductor of the present invention is a magnetic powder-wire coil co-firing inductor (an integrated-molding inductor or an integrated inductor) with a compact structure. There is few air gap or almost no air gap between the magnetic core and the wire coil, which is advantageous to miniaturization of inductors. Where magnetic powder-wire coil co-firing means that magnetic powder and the wire coil are heat treated and annealed together, it is similar to an integrated (or one-piece) molding in which magnetic powder is filled around the wire coil, then pressed, heated and annealed. The details are as follows.

In addition, the magnetic powder-wire coil co-firing inductor provided by the present invention also has a high insulation withstand voltage (the insulation resistance of 200V/10 s is greater than 1MΩ), which can improve an applied power supply efficiency and reliability. Further, a high-reliability power supply can improve the applied electric device efficiency and reduce quality inspection costs, and thus can ensure a long-term stable operation of electronic devices.

The method, though an integrated molding (one-piece molding), or a magnetic powder-wire coil co-firing, for manufacturing the inductor of the present invention, is not limited to the material type of soft magnetic powder, and various soft magnetic powder can be used, thus reducing the production cost and manufacturing difficulty. At the same time, when manufacturing the inductor of the present invention, the particle size of the magnetic powder used is not limited, and there is no need to limit the particle size of the soft magnetic powder to obtain the magnetic core of the inductor with a high density and a high magnetic permeability, thus avoiding waste of raw materials and high costs.

The method of magnetic powder-wire coil co-firing for manufacturing an inductor of the present invention includes the following steps:
a compression molding step, specifically, pre-installing a wire coil in a cavity of the mold, filling the cavity with magnetic powder surrounding the wire coil, applying pressure for molding to obtain a raw inductor with the wire coil buried inside the magnetic core and leads of the wire coil exposed outside the magnetic core; and
an annealing step, specifically, placing the raw inductor in a heat furnace for calcinating and annealing so as to release residual stress inside the magnetic core and obtain the integrated inductor with required electromagnetic properties.

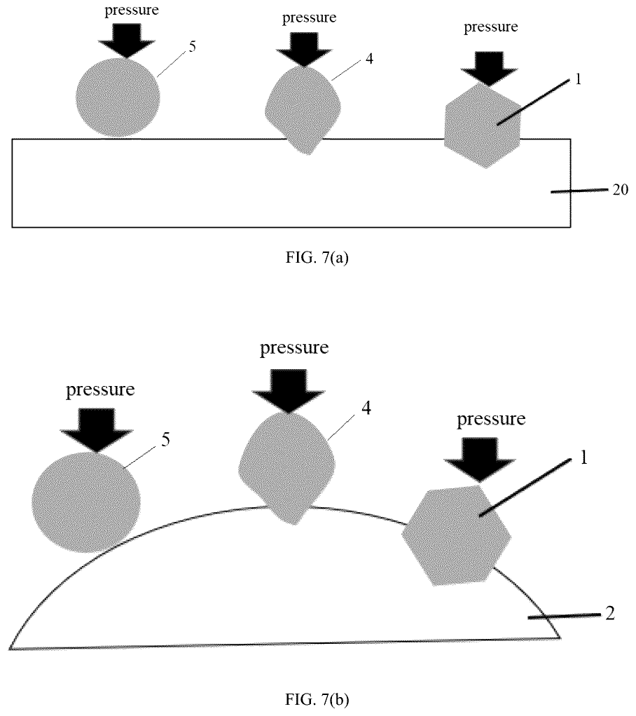

At the compression molding step, the soft magnetic powder for preparing the magnetic core contains spherical particles with a sphericity greater than 95%; a weight ratio of the spherical particles in the soft magnetic powder is more than 50 wt %, preferably more than 80 wt %, and more preferably almost 100%. A lower weight ratio of spherical particles would cause a poor insulation withstand voltage of the inductor. Adding an appropriate ratio of non-spherical particles in the soft magnetic powder can increase a density of the inductor and improve the magnetic permeability. If the soft magnetic powder is all or almost spherical particles, a higher withstand voltage can be obtained, while the inductor can still obtain a high magnetic permeability due to the high-pressure molding. Referring to FIGS. 7(a) and 7(b), the reasons of using the soft magnetic powder with spherical particles in the present invention is that: spherical particles 5 of the soft magnetic powder have smooth particle surfaces which are tangent to the surfaces of the wire coil 20 or other particles 2, and almost no sharps or bulges penetrate the inside of the wire coil 20 (such as copper wire) or other particles. While non-spherical powder particle 1 has sharps or protruding on their particle surfaces, under a high pressure, the sharps can easily penetrate the surfaces into an inner of the wire coil 20 (as shown in FIG. 7(a)) or into an inner of other particle 2 of the soft magnetic powder (as shown in FIG. 7(b)). If there are sharps on spherical surfaces of soft magnetic particles 4, when the sharps come into contact with the adjacent wire coil 20 (such as a copper wire), they will easily cut into the wire, causing a short circuit in the circuit connected to the inductor; while polygonal magnetic particles are easier to cut into the wire coil, more likely causing a short circuit.

Soft magnetic powder can be Fe-based powder such as Fe powder, Fe—Si powder, Fe—Ni powder, Fe—Si—Cr powder, Fe—Si—Al powder; soft magnetic powder can be Fe-based amorphous magnetic powder or can be nanocrystalline magnetic powder; one or a mixture of two or more. There is an insulating layer on the surface of each soft magnetic particle. The insulating layer has a high resistivity and flexibility such that the particles are not in complete contact to reduce an eddy current and increase an insulation resistance of the inductor. Further, the insulating material of the insulating layer has a bonding property to improve the strength of the inductor.

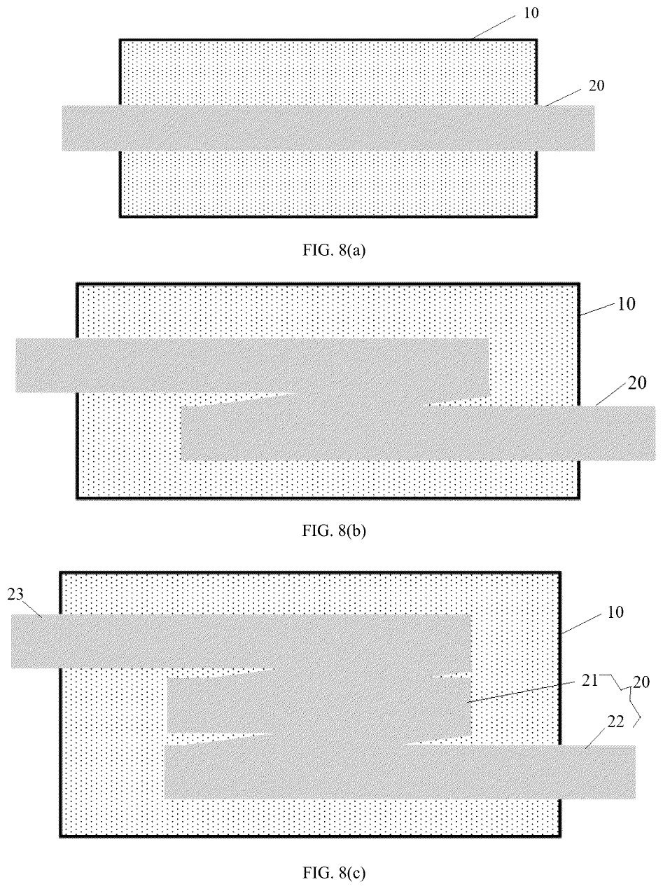

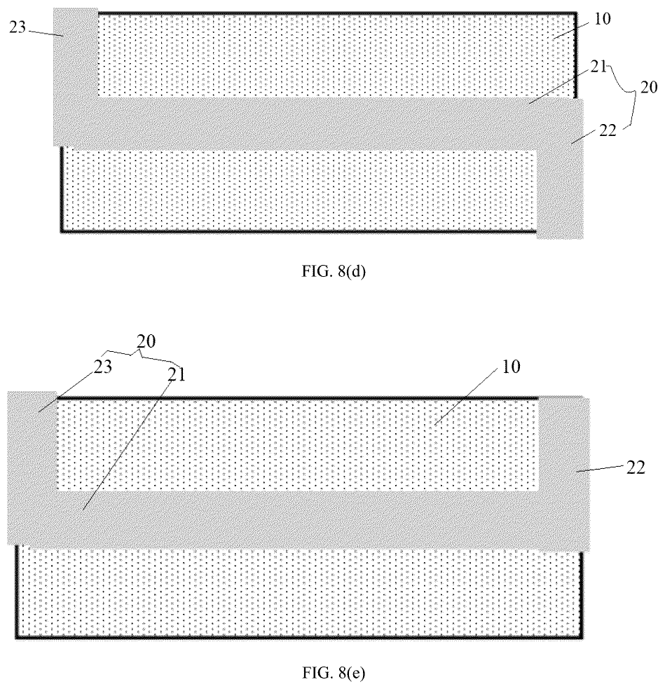

The wire coil can be a metal conductor with a rectangular or circular or other shaped cross-section, and the wire coil can be a linear or spiral coil, wherein the number of turns in the wire coil is less than 4, preferably 2 turns. In order to obtain a higher withstand voltage, more preferably, the wire coil is a single-turn and straight wire. According to the definition L∝μT2, where L is an inductance, is a magnetic permeability, and T is the number of turns in the wire coil, it can be known that increasing the number of turns can increase the inductance of the inductor, but too many turns of the coil will cause a high DC resistance and difficulty of a flat-coil inductor. Since the magnetic core of the inductor of the present invention has high magnetic permeability, the wire coil does not require multiple turns to obtain the required electromagnetic properties. Reducing turns in wire coil can help reduce the risk of direct contact (short circuit) between wires due to a high molding pressure or sharps on the particle surface of the magnetic powder. There is a risk of direct contact (short circuit) between the wires when a protruding/sharp on the magnetic particle surface penetrates into the interior of two adjacent wires at the same time. A linear/straight wire coil can completely avoid the risk of short circuits (electrical connection) in adjacent wires. The number of wire coil turns is the number of times that the metal conductor passes through the magnetic field (namely, magnetic field lines). Refer to FIGS. 8(a)-8(e), where FIGS. 8(a), 8(d), and 8(e) show a single-turn wire coil 20 embedded in the magnetic core 10, FIG. 8(b) is a 2-turn wire coil 20 embedded in the magnetic core 10, and FIG. 8(c) is a 3-turn wire coil 20 embedded in the magnetic core 10. Herein, a “straight” or “linear” shape mainly refers to a shape of coil main body 21, excluding leads 22 and 23 on both sides of the coil main body 21, and the leads can be co-line with the coil main body 21 or bent from both sides of the coil main body. The wire coil is embedded in the center of the magnetic core, specifically, the coil main body 21 is embedded through a centerline of the magnetic core 10 with leads 22 and 23 exposed outside of the surface of the magnetic core 10. The edges and outer shape of the magnetic core can be non-linear or not straight, as shown in FIGS. 8(d) and 8(e).

The present invention adopts an integrated molding or co-firing process, and the molding pressure is 12˜24 T/cm², such as 12 T/cm², 13 T/cm², 14 T/cm², 15 T/cm², 16 T/cm², 17 T/cm², 18 T/cm², 19 T/cm², 20 T/cm², 21 T/cm², 22 T/cm², or any value in the interval between any two values as the endpoints; preferably 16˜22 T/cm², and more preferably 18˜20 T/cm². Appropriately increasing the molding pressure can increase the density of the magnetic core and increase the magnetic permeability. However, if the molding pressure is too high, there is a risk of reducing the insulating properties of the inductor, especially for spiral coils with a number of turns greater than 1. In addition, when the molding pressure increases to a certain level, a density of the magnetic core tends to be stable and will not continue to increase. Excessive pressure is not economic; while too low pressure may lead the inductor with a poor strength and a low magnetic permeability, and electromagnetic properties cannot meet the needs.

The compression molding step will cause elastic deformation and plastic deformation of the soft magnetic powder, so a raw inductor needs to be annealed to release internal stress. At the same time, annealing can also eliminate defects inside the magnetic powder. Therefore, annealing can increase the initial magnetic permeability of the magnetic core, reduce iron loss, and improve the mechanical strength of the inductor. Depending on the type of soft magnetic powder, the annealing temperature is generally between 40° and 850° C., such as 400° C., 450° C., 500° C., 550° C., 600° C., 650° C., 700° C., 750° C., 800° C., 850° C. and any value in the interval between any two values as the endpoints. If the annealing temperature is too low, it will not be enough to release the internal residual stress, resulting in a low magnetic permeability and high loss; if the annealing temperature is too high, the insulation layer on the particle surface will be damaged, the initial magnetic permeability will be reduced, and the eddy current loss will be increased.

The integrated inductor of the present invention, comprising a magnetic core and a wire coil embedded inside the magnetic core, is manufactured by means of a co-firing process, namely, an integrated molding or a one-piece molding with soft magnetic powder and the wire coil. Fe-based soft magnetic powder is preferably used and contains spherical particles with a sphericity greater than 95%; and a weight ratio of the spherical particles in the soft magnetic powder is more than 50 wt %, preferably more than 80 wt %, and more preferably almost 100%. The wire coil is preferably a copper conductor, preferably a linear copper conductor, thus obtaining a copper-iron co-fired inductor.

In some embodiments, the insulation resistance value (200V/10 s) of the inductor of the present invention is greater than 1 MΩ, and the magnetic permeability of the inductor is greater than 40. In some embodiments, the magnetic permeability of the inductor is 40-75, the relative density is 70%-95%, the insulation resistance at 10V/10 s is greater than 5MΩ, and the insulation resistance at 200V/10 s is greater than 1 MΩ.

With reference to FIGS. 2-8(e), the numbers marked on the powder particles in FIGS. 2-4 are sphericity values. The method for manufacturing the integrated inductor through soft magnetic powder-wire coil co-firing in the present invention will be described in detail below in conjunction with various non-limiting embodiments and comparative examples, and the electromagnetic properties of the obtained inductor will be measured.

### Comparative Example 1

A method of manufacturing an integrated inductor in the first comparative example includes a compression molding step and an annealing step.

At the compression molding step, installing a wire coil in a mold first, filling the mold cavity with soft magnetic powder around the wire coil, pressing and molding at a pressure of 8 T/cm², and obtaining a raw inductor with the wire coil buried inside the magnetic core and leads of the wire coil partially exposed outside of the magnetic core. The soft magnetic powder for preparing the magnetic core is iron-silicon-aluminum alloy powder(particles), and contains 100 wt % spherical particles with a sphericity of not less than 95%. A surface image of the iron-silicon-aluminum alloy particles is shown in FIG. 2. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 1

A method of manufacturing an integrated inductor in the first embodiment includes a compression molding step and an annealing step.

At the compression molding step, installing a wire coil in a mold first, filling the mold cavity with soft magnetic powder around the wire coil, pressing and molding at a pressure of 12 T/cm², and obtaining a raw inductor with the wire coil buried inside the magnetic core and leads of the wire coil partially exposed outside of the magnetic core. The soft magnetic powder for preparing the magnetic core is iron-silicon-aluminum alloy powder(particles), and contains 100 wt % spherical particles with a sphericity not less than 95%. A surface image of the iron-silicon-aluminum alloy particles is shown in FIG. 2. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 2

A method of manufacturing an integrated inductor in accordance with the second embodiment includes a compression molding step and an annealing step.

At the compression molding step, installing a wire coil in a mold first, filling the mold cavity with soft magnetic powder around the wire coil, pressing and molding at a pressure of 16 T/cm², and obtaining a raw inductor with the wire coil buried inside the magnetic core and leads of the wire coil partially exposed outside of the magnetic core. The soft magnetic powder for preparing the magnetic core is iron-silicon-aluminum alloy powder(particles), and contains 100 wt % spherical particles with a sphericity not less than 95%. A surface image of the iron-silicon-aluminum alloy particles is shown in FIG. 2. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 3

A method of manufacturing an inductor in accordance with the third embodiment includes a compression molding step and an annealing step.

At the compression molding step, installing a wire coil in a mold first, filling the mold cavity with soft magnetic powder around the wire coil, pressing and molding at a pressure of 20 T/cm², and obtaining a raw inductor with the wire coil buried inside the magnetic core and leads of the wire coil partially exposed outside of the magnetic core. The soft magnetic powder for preparing the magnetic core is iron-silicon-aluminum alloy powder(particles), and contains 100 wt % spherical particles with a sphericity not less than 95%. A surface image of the iron-silicon-aluminum alloy particles is shown in FIG. 2. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 2

A method of manufacturing an inductor in accordance with the second comparative example includes a compression molding step and an annealing step.

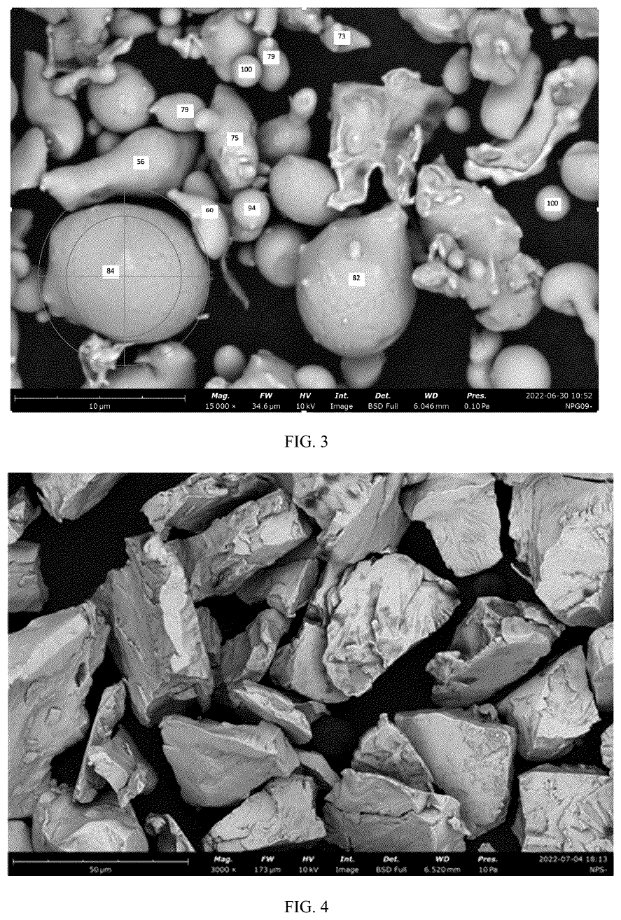

At the compression molding step, installing a wire coil in a mold first, filling the mold cavity with soft magnetic powder around the wire coil, pressing and molding at a pressure of 8 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 8:2 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 80%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 4

A method of manufacturing an inductor in accordance with the fourth embodiment includes a compression molding step and an annealing step.

At the compression molding step, installing a wire coil in a mold first, filling the mold cavity with soft magnetic powder around the wire coil, pressing and molding at a pressure of 12 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 8:2 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 80%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 5

A method of manufacturing an inductor in accordance with the fifth embodiment includes a compression molding step and an annealing step.

At the compression molding step, installing a wire coil in a mold first, filling the mold cavity with soft magnetic powder around the wire coil, pressing and molding at a pressure of 16 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 8:2 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 80%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 6

A method of manufacturing an inductor in accordance with the sixth embodiment includes a compression molding step and an annealing step.

At the compression molding step, installing a wire coil in a mold first, filling the mold cavity with soft magnetic powder around the wire coil, pressing and molding at a pressure of 20 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 8:2 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 80%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 3

A method of manufacturing an inductor in accordance with the third comparative example includes a compression molding step and an annealing step.

At the compression molding step, installing a wire coil in a mold first, filling the mold cavity with soft magnetic powder around the wire coil, pressing and molding at a pressure of 8 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 5:5 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 7

A method of manufacturing an inductor in accordance with the seventh embodiment includes a compression molding step and an annealing step.

At the compression molding step, installing a wire coil in a mold first, filling the mold cavity with soft magnetic powder around the wire coil, pressing and molding at a pressure of 12 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 5:5 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 8

A method of manufacturing an inductor in accordance with the eighth embodiment includes a compression molding step and an annealing step.

At the compression molding step, installing a wire coil in a mold first, filling the mold cavity with soft magnetic powder around the wire coil, pressing and molding at a pressure of 16 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 5:5 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Embodiment 9

A method of manufacturing an inductor in accordance with the ninth embodiment includes a compression molding step and an annealing step.

At the compression molding step, installing a wire coil in a mold first, filling the mold cavity with soft magnetic powder around the wire coil, pressing and molding at a pressure of 20 T/cm², and obtaining a raw inductor with the wire coil buried inside the magnetic core and leads of the wire coil partially exposed outside of the magnetic core. The soft magnetic powder for preparing the magnetic core is a mixture of iron-silicon-aluminum alloy powder and iron-silicon alloy powder, and a mixing ratio is 5:5 by weight, where a sphericity of the iron-silicon-aluminum alloy powder/particles is not less than 95% (particle surface image as shown in FIG. 2), and a sphericity of iron-silicon alloy powder/particles is not less than 50% (particle surface image as shown in FIG. 3). The weight ratio of spherical particles in the soft magnetic powder is 80%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 4

A method of manufacturing an inductor in accordance with the fourth comparative example includes a compression molding step and an annealing step.

At the compression molding step, installing a wire coil in a mold first, filling the mold cavity with soft magnetic powder around the wire coil, pressing and molding at a pressure of 8 T/cm², and obtaining a raw inductor with the wire coil buried inside the magnetic core and leads of the wire coil partially exposed outside of the magnetic core. The soft magnetic powder for preparing the magnetic core is iron-silicon-chromium alloy powder/particles with a sphericity of not less than 50% (particle surface image as shown in FIG. 3). A weight ratio of spherical particles in the soft magnetic powder is 100%, that is, the soft magnetic particles are all spherical particles with a sphericity of not less than 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 5

A method of manufacturing an inductor in accordance with the fifth comparative example includes a compression molding step and an annealing step.

At the compression molding step, installing a wire coil in a mold first, filling the mold cavity with soft magnetic powder around the wire coil, pressing and molding at a pressure of 12 T/cm², and obtaining a raw inductor with the wire coil buried inside the magnetic core and leads of the wire coil partially exposed outside of the magnetic core. The soft magnetic powder for preparing the magnetic core is iron-silicon-chromium alloy powder/particles with a sphericity of not less than 50% (particle surface image as shown in FIG. 3). A weight ratio of spherical particles in the soft magnetic powder is 100%, that is, the soft magnetic particles are all spherical particles with a sphericity of not less than 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 6

A method of manufacturing an inductor in accordance with the sixth comparative example includes a compression molding step and an annealing step.

At the compression molding step, installing a wire coil in a mold first, filling the mold cavity with soft magnetic powder around the wire coil, pressing and molding at a pressure of 16 T/cm², and obtaining a raw inductor with the wire coil buried inside the magnetic core and leads of the wire coil partially exposed outside of the magnetic core. The soft magnetic powder for preparing the magnetic core is iron-silicon-chromium alloy powder/particles with a sphericity of not less than 50% (particle surface image as shown in FIG. 3). A weight ratio of spherical particles in the soft magnetic powder is 100%, that is, the soft magnetic particles are all spherical particles with a sphericity of not less than 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 7

A method of manufacturing an inductor in accordance with the seventh comparative example includes a compression molding step and an annealing step.

At the compression molding step, installing a wire coil in a mold first, filling the mold cavity with soft magnetic powder around the wire coil, pressing and molding at a pressure of 20 T/cm², and obtaining a raw inductor with the wire coil buried inside the magnetic core and leads of the wire coil partially exposed outside of the magnetic core. The soft magnetic powder for preparing the magnetic core is iron-silicon-chromium alloy powder/particles with a sphericity of not less than 50% (particle surface image as shown in FIG. 3). A weight ratio of spherical particles in the soft magnetic powder is 100%, that is, the soft magnetic particles are all spherical particles with a sphericity of not less than 50%. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 8

A method of manufacturing an inductor in accordance with the eighth comparative example includes a compression molding step and an annealing step.

At the compression molding step, installing a wire coil in a mold first, filling the mold cavity with soft magnetic powder around the wire coil, pressing and molding at a pressure of 8 T/cm², and obtaining a raw inductor with the wire coil buried inside the magnetic core and leads of the wire coil partially exposed outside of the magnetic core. The soft magnetic powder for preparing the magnetic core is irregular-shaped or non-spherical iron-silicon-aluminum alloy particles with a particle surface image as shown in FIG. 4. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 9

A method of manufacturing an inductor in accordance with the ninth comparative example includes a compression molding step and an annealing step.

At the compression molding step, installing a wire coil in a mold first, filling the mold cavity with soft magnetic powder around the wire coil, pressing and molding at a pressure of 12 T/cm², and obtaining a raw inductor with the wire coil buried inside the magnetic core and leads of the wire coil partially exposed outside of the magnetic core. The soft magnetic powder for preparing the magnetic core is irregular-shaped or non-spherical iron-silicon-aluminum alloy particles with a particle surface image as shown in FIG. 4. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 10

A method of manufacturing an inductor in accordance with the tenth comparative example includes a compression molding step and an annealing step.

At the compression molding step, installing a wire coil in a mold first, filling the mold cavity with soft magnetic powder around the wire coil, pressing and molding at a pressure of 16 T/cm², and obtaining a raw inductor with the wire coil buried inside the magnetic core and leads of the wire coil partially exposed outside of the magnetic core. The soft magnetic powder for preparing the magnetic core is irregular-shaped or non-spherical iron-silicon-aluminum alloy particles with a particle surface image as shown in FIG. 4. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

### Comparative Example 11

A method of manufacturing an inductor in accordance with the eleventh comparative example includes a compression molding step and an annealing step.

At the compression molding step, installing a wire coil in a mold first, filling the mold cavity with soft magnetic powder around the wire coil, pressing and molding at a pressure of 20 T/cm², and obtaining a raw inductor with the wire coil buried inside the magnetic core and leads of the wire coil partially exposed outside of the magnetic core. The soft magnetic powder for preparing the magnetic core is irregular-shaped or non-spherical iron-silicon-aluminum alloy particles with a particle surface image as shown in FIG. 4. The wire coil adopts a linear copper conductor.

At the annealing step, heating and annealing the raw inductor in a furnace at 700° C. for about one hour to obtain the integrated inductor, so that residual stress in the magnetic core generated at the compression molding step can be released, and the inductor can obtain the required electromagnetic properties.

Measure a density and magnetic permeability of the magnetic core of the integrated inductor obtained in the above-mentioned embodiments 1-9 and comparative Examples 1-11. Cut the integrated inductor into small pieces and measure the density of the magnetic core through a water drainage technology. Where a relative density is equal to a density of the magnetic core divided by a density of the magnetic powder. Use an LCR meter to measure the initial inductance of the inductor, and calculate the magnetic permeability μ through the formula μ=L*le/(Ae*T²), where le is an effective magnetic length, Ae is an effective magnetic cross section, and T is the number of turns in the wire coil. Use a withstand voltage tester to test the dielectric withstand voltage, wherein place the inductor between two parallel electrode plates, apply a certain voltage between the two electrodes, and check the withstand voltage. The test results are shown in Table 1.

TABLE 1
Properties of Integrated Inductors

| | soft magnetic | | | | | | |
|---|---|---|---|---|---|---|---|
| | powder (weight | | Molding | | | Insulation | Insulation |
| | ratio % of spherical | | pressure | Relative | Magnetic | resistance | resistance |
| | particles) | Sphericity | (T/cm²) | density | permeability | 10 V/10 s (Ω) | 200 V/10 s (Ω) |
| Comparative | Fe—Si—Al (100% | ≥95% | 8 | 77% | 29 | 3.85E+10 | 1.27E+10 |
| example 1 | spherical particles) | | | | | | |
| Embodiment 1 | Fe—Si—Al (100% | ≥95% | 12 | 81% | 41 | 1.63E+10 | 7.60E+09 |
| | spherical particles) | | | | | | |
| Embodiment 2 | Fe—Si—Al (100% | ≥95% | 16 | 84% | 55 | 1.74E+10 | 8.80E+09 |
| | spherical particles) | | | | | | |
| Embodiment 3 | Fe—Si—Al (100% | ≥95% | 20 | 87% | 62 | 1.69E+10 | 8.20E+09 |
| | spherical particles) | | | | | | |
| Comparative | Fe—Si—Al:Fe—Si = | ≥50% | 8 | 79% | 31 | 3.39E+08 | 1.64E+08 |
| example 2 | 8:2 (80% spherical | | | | | | |
| | particles) | | | | | | |
| Embodiment 4 | Fe—Si—Al:Fe—Si = | ≥50% | 12 | 83% | 46 | 1.56E+08 | 8.80E+07 |
| | 8:2 (80% spherical | | | | | | |
| | particles) | | | | | | |
| Embodiment 5 | Fe—Si—Al:Fe—Si = | ≥50% | 16 | 86% | 50 | 1.64E+08 | 8.00E+07 |
| | 8:2 (80% spherical | | | | | | |
| | particles) | | | | | | |
| Embodiment 6 | Fe—Si—Al:Fe—Si = | ≥50% | 20 | 88% | 58 | 1.60E+07 | 7.50E+07 |
| | 8:2 (80% spherical | | | | | | |
| | particles) | | | | | | |
| Comparative | Fe—Si—Al:Fe—Si = | ≥50% | 8 | 84% | 39 | 3.39E+07 | 1.92E+07 |
| example 3 | 5:5 (50% spherical | | | | | | |
| | particles) | | | | | | |
| Embodiment 7 | Fe—Si—Al:Fe—Si = | ≥50% | 12 | 87% | 53 | 3.26E+07 | 8.15E+06 |
| | 5:5 (50% spherical | | | | | | |
| | particles) | | | | | | |
| Embodiment 8 | Fe—Si—Al:Fe—Si = | ≥50% | 16 | 91% | 62 | 1.16E+07 | 4.88E+06 |
| | 5:5 (50% spherical | | | | | | |
| | particles) | | | | | | |
| Embodiment 9 | Fe—Si—Al:Fe—Si = | ≥50% | 20 | 92% | 68 | 8.03E+06 | 2.35E+06 |
| | 5:5 (80% spherical | | | | | | |
| | particles) | | | | | | |
| Comparative | Fe—Si—Cr (100% | ≥50% | 8 | 83% | 46 | 7.35E+05 | 1.91E+05 |
| example 4 | spherical particles) | | | | | | |
| Comparative | Fe—Si—Cr (100% | ≥50% | 12 | 88% | 57 | 1.65E+05 | 1.00E+05 |
| example 5 | spherical particles) | | | | | | |
| Comparative | Fe—Si—Cr (100% | ≥50% | 16 | 91% | 63 | 1.01E+05 | Low |
| example 6 | spherical particles) | | | | | | |
| Comparative | Fe—Si—Cr (100% | ≥50% | 20 | 93% | 70 | 3.01E+03 | Low |
| example 7 | spherical particles) | | | | | | |
| Comparative | Irregular Fe—Si—Al | non | 8 | 72% | 19 | 7.80E+07 | 1.00E+05 |
| example 8 | | | | | | | |
| Comparative | Irregular Fe—Si—Al | non | 12 | 76% | 31 | 5.60E+06 | Low |
| example 9 | | | | | | | |
| Comparative | Irregular Fe—Si—Al | non | 16 | 81% | 45 | 2.15E+05 | Low |
| example 10 | | | | | | | |
| Comparative | Irregular Fe—Si—Al | non | 20 | 84% | 55 | 1.21E+02 | Low |
| example 11 | | | | | | | |

The results in Table 1 show that the inductors provided in the comparative examples and the embodiments of the present invention has a higher magnetic permeability in the magnetic core and a higher dielectric withstand voltage compared to the inductor made in the prior art.

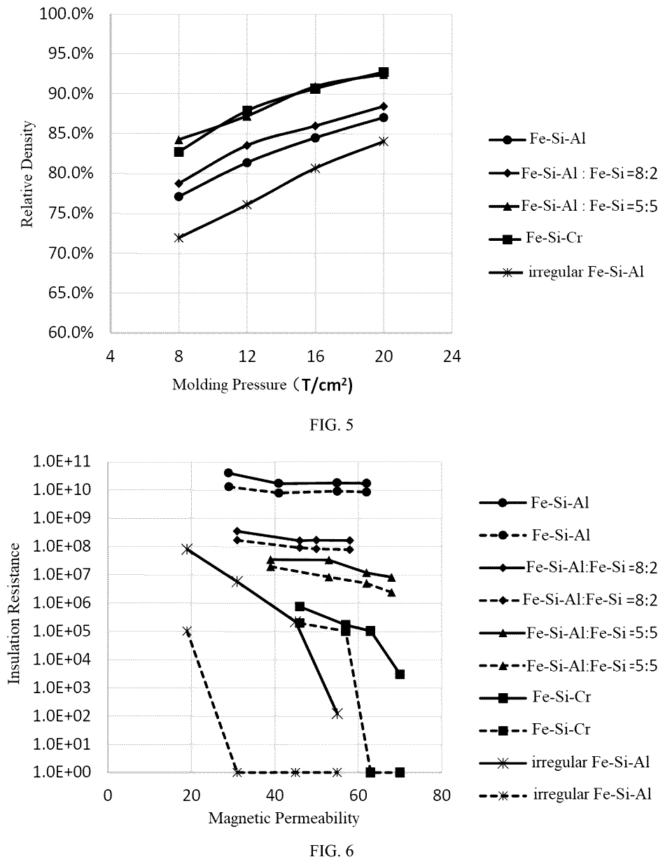

In the above-mentioned embodiments 1-9^{th} and comparative examples 1-11^{th}, the molding pressure and the relative density of the magnetic core of the inductor are measured. The measurement results refer to FIG. 5. The measurement results show that the greater the molding pressure, the higher the relative density of the magnetic core.

The inductors obtained in the above-mentioned embodiments 1-9th and comparative examples 1-6^{th} are measured for the magnetic permeability and the insulation resistance, with reference to the relationship diagram between the magnetic permeability and the insulation resistance shown in FIG. 6, where, the solid line represents the insulation resistance of 10V/10 s, and the dotted line represents the insulation resistance of 200V/10 s. The measurement results show that:
when the soft magnetic powder for preparing the magnetic core of the inductor are all spherical particles with a high sphericity, the inductor has the highest dielectric withstand voltage/insulation resistance, its magnetic permeability is 29˜62, and when the magnetic permeability rises from 41 to 62, the dielectric withstand voltage/insulation resistance will not decrease;
when the soft magnetic powder for preparing the magnetic core of the inductor contains 80 wt % spherical particles with a high sphericity, and the dielectric withstand voltage/insulation resistance is reduced by 2 orders of magnitude, and the magnetic permeability is between 31 and 58; when the soft magnetic powder for preparing the magnetic core of the inductor contains 50 wt % spherical particles with a high sphericity, the dielectric withstand voltage of the inductor continues to be reduced by one order of magnitude, at the same time, as the molding pressure increases, the magnetic permeability increases and the dielectric withstand voltage worsens;
if spherical particles with high sphericity are not contained in the soft magnetic powder, the insulation resistance of the inductor will be greatly deteriorated, especially under the condition of 200V/10 s, electrical conduction (short circuit) will occur; and
when the molding pressure is 8 T/cm2, although the spherical particles are contained in the soft magnetic powder which ensure the dielectric withstand voltage/insulation resistance of the inductor, the magnetic permeability is low, which is not advantageous for miniaturization of the inductor and affects the efficiency of the power supply that the inductor is applied in.

In view of the above, by selecting an appropriate proportion of soft magnetic powder with a high sphericity and corresponding molding pressure, an integrated inductor with high magnetic permeability and high dielectric withstand voltage/insulation resistance can be obtained. In the present invention, the integrated inductor, comprising a magnetic core made of soft magnetic powder and a wire coil embedded inside the magnetic core, is manufactured though magnetic powder-wire coil co-firing. Fe-based soft magnetic powder is preferably used, and spherical particles with a sphericity of not less than 95% is used. The weight proportion of spherical particles in the soft magnetic powder is not less than 50 wt %, preferably not less than 80 wt %, and more preferably all the soft magnetic powders are spherical particles. The wire coil is preferably a copper conductor, preferably a linear copper conductor, and a copper-iron co-firing inductor is prepared according to the above method. The molding pressure is 12˜24 T/cm², preferably 16˜22 T/cm², and more preferably 18˜20 T/cm². Appropriately increasing the molding pressure can increase the density of the magnetic core and increase the magnetic permeability. However, if the molding pressure is too high, there is a risk of reducing the insulating properties of the inductor, especially for the inductor with a number of turns in the wire coil greater than 1. If the molding pressure is too low, the inductance strength may be poor and the magnetic permeability may be poor, and the electromagnetic properties cannot meet the needs.

In some embodiments, the insulation resistance value (200V/10 s) of the magnetic powder-wire coil co-firing inductor manufactured in the present invention is greater than 1 MΩ, and the magnetic permeability of the magnetic core is greater than 40. In some embodiments, the magnetic permeability of the inductor is 40-75, the relative density is 70%-95%, the insulation resistance at 10V/10 s is greater than 5MΩ, and the insulation resistance at 200V/10 s is greater than 1 MΩ.

The technical features of the above embodiments can be combined arbitrarily. In order to make the description simple, all possible combinations of the technical features in the above embodiments are not described. However, as long as there is no contradiction in the combination of these technical features It is considered to be the range described in this specification.

The above examples only represent several embodiments of the present invention, and the descriptions thereof are specific and detailed, but should not be construed as a limitation on the scope of the invention patent. It should be pointed out that for those of ordinary skill in the art, without departing from the concept of the present invention, several modifications and improvements can also be made, which all belong to the protection scope of the present invention. Therefore, the protection scope of the patent of the present invention should be subject to the appended claims.

What is claimed is:

1. An inductor, comprising:
a magnetic core, made of soft magnetic powder; and
a wire coil embedded inside the magnetic core through an integrated molding; wherein the soft magnetic powder contains more than 50 wt % of spherical particles; the inductor components are made by integrated molding at a molding pressure of 12˜24 T/cm².

2. The inductor as claimed in claim 1, wherein a sphericity of the spherical particles is not less than 95%; the soft magnetic powder contains more than 80 wt % spherical particles; and the molding pressure is 16˜22 T/cm².

3. The inductor as claimed in claim 2, wherein all the soft magnetic powders are spherical particles; the molding pressure is 18˜20 T/cm².

4. The inductor as claimed in claim 1, wherein the soft magnetic powder is one or more of Fe powder, Fe—Si powder, Fe—Ni powder, Fe—Si—Cr powder, or Fe—Si—Al powder; or the soft magnetic powder is Fe-based amorphous magnetic powder and/or nanocrystalline magnetic powder.

5. The inductor as claimed in claim 1, wherein the wire coil is a linear or spiral coil, and a number of turns in the wire coil is less than 4.

6. The inductor as claimed in claim 1, wherein a number of turns in the wire coil is 2.

7. The inductor as claimed in claim 1, wherein the wire coil is a single-turn and straight coil.

8. The inductor as claimed in claim 1, wherein the wire coil is a copper conductor and is straight.

9. The inductor as claimed in claim 1, wherein the soft magnetic powder is provided with an insulating layer on each particle surface.

10. The inductor as claimed in claim 9, wherein the insulating layer has a high resistivity and flexibility such that the particles are not in complete contact to reduce an eddy current and increase an insulation resistance of the inductor; and insulating material of the insulating layer has a bonding property to improve a strength of the inductor.

11. A method for manufacturing an inductor, comprising steps of:
a pressing and molding step; and
an annealing step;
wherein, at the pressing and molding step, placing a wire coil in a mold, filling a cavity of the mold with soft magnetic powder surrounding the wire coil, molding at a pressure of 12˜24 T/cm² to obtain a raw inductor with the wire coil buried inside a magnetic core and leads of the wire coil exposed on a surface of the magnetic core; the soft magnetic powder contains more than 50 wt % spherical particles; and
at the annealing step, placing the raw inductor in a heat furnace for calcinating and annealing so as to release residual stress inside the magnetic core and obtain the integrated inductor.

12. The method as claimed in claim 11, wherein at the pressing and molding step, a sphericity of the spherical particles is not less than 95%; the soft magnetic powder contains more than 80 wt % spherical particles; and the molding pressure is 16˜22 T/cm²; and at the annealing step, a temperature in the heat furnace is 400˜850° C.

13. The method as claimed in claim 11, wherein at the pressing and molding step, all the soft magnetic powders are spherical particles; the molding pressure is 18˜20 T/cm².

14. The method as claimed in claim 11, wherein the soft magnetic powder is one or more of Fe powder, Fe—Si powder, Fe—Ni powder, Fe—Si—Cr powder, or Fe—Si—Al powder; or the soft magnetic powder is Fe-based amorphous magnetic powder and/or nanocrystalline magnetic powder.

15. The method as claimed in claim 11, wherein the wire coil is a linear or spiral coil, and a number of turns in the wire coil is less than 4.

16. The method as claimed in claim 11, wherein a number of turns in the wire coil is 2.

17. The method as claimed in claim 11, wherein the wire coil is a single-turn and straight coil.

18. The method as claimed in claim 11, wherein the wire coil is a copper conductor and is straight.

19. The method as claimed in claim 11, wherein the soft magnetic powder is provided with an insulating layer on each particle surface.

20. The method as claimed in claim 19, wherein the insulating layer has a high resistivity and flexibility such that the particles are not in complete contact to reduce an eddy current and increase an insulation resistance of the inductor; and insulating material of the insulating layer has a bonding property to improve a strength of the inductor.
